(19) United States
(12) Patent Application Publication
(10) Pub. No.: US 2016/0242351 A1
(43) Pub. Date: Aug. 25, 2016

(54) LEVERAGE-ENHANCING ATTACHMENT AID FOR DIGGING AND PRYING TOOLS AND METHOD OF USE

(71) Applicant: James Alan Richmond, Redding, CA (US)

(72) Inventor: James Alan Richmond, Redding, CA (US)

(21) Appl. No.: 14/945,352

(22) Filed: Nov. 18, 2015

Related U.S. Application Data
(60) Provisional application No. 62/094,143, filed on Dec. 19, 2014.

(51) Int. Cl. A01B 1/02; A01B 1/00; E02F 3/02

(52) U.S. Cl. CPC A01B 1/028; E02F 3/02; A01B 1/00

(57) ABSTRACT

A novel aid for digging and prying implements is disclosed. The innovative aid affords the user of shovels, prying tools and the like to gain leverage by substantially increasing the mechanical advantage for digging, prying and lifting resistive or heavy loads. The novel digging and prying aid comprises an attachment collar, a lever arm and extension bar and a foot base. A fulcrum point is created by an articulating joint formed between the lever arm and extension bar. When deployed, the aid provides a mechanical advantage for raising the blade of a shovel or prying tool when engaged in digging, shoveling or prying actions.

### PRIORITY CLAIM

This non-provisional utility application claims the benefit of U.S. Provisional Application No. 62/094,143, filed on Dec. 19, 2014.

### FIELD OF THE INNOVATION

This innovation relates to aids and tools to assist users of digging and prying implements, such as shovels and pry bars and other leverage tools particularly to reduce effort required to operate the implement on the part of the user.

### BACKGROUND

Digging and prying implements typically are used without any aid to assist the user in exertion when using implements such as shovels and prying tools, or other leveraging tools. Many tasks that require such implements are difficult and tire the user quickly. Moreover, the user may strain joints and muscles. An aid that provides a substantial mechanical advantage so the user may gain leverage when digging and prying resistive and heavy objects is desired that is simple to deploy and lightweight to carry.

### SUMMARY

The present disclosure relates to an innovative leverage-enhancing attachment attachment for digging and prying implements, to ergonomically aid in digging, prying or lifting using shovels, pitch forks, trenching tools, shingle removing (roofing) tools and the like. Embodiments of the innovative tool attachment comprise a pivot stand member that articulates with a stationary support stem extending from an attachment collar. The attachment collar is adapted to attach the innovative leverage-enhancing attachment to the shaft of a digging or prying implement, such as a shovel or a shingle remover, by clasping about the shaft of said implement. The pivot stand comprises an elongated extension bar member, having a first end adapted to articulate with the attachment collar support stem, thereby forming articulating joint, whereby the foot stand pivots about the articulating joint. It will be seen that the articulating joint will act as a fulcrum to facilitate digging and prying operations when the innovative leverage-enhancing attachment is deployed. The innovative leverage-enhancing attachment assists a user of the digging implement by providing an enhanced mechanical advantage to aid in lifting a mass using the implement. The user gains leverage by the substantial mechanical advantage afforded by the innovation described herein. The second end of the foot stand is affixed to a foot base adapted to stabilize the innovative leverage-enhancing attachment when the aid is deployed as will be described below, as well as to provide an ergonomic foothold for enhancing the initiation of digging or prying operations using the user's foot to press the blade of the implement into the ground or under an object to lift or pry from a surface. Greater detail of the foregoing is provided in the Detailed Description.

The enhanced mechanical advantage is realized by a first mechanical advantage already achieved by the relative lengths of the upper shaft portion of the digging or prying implement between the free end of the shaft and the attachment point of the attachment collar on the shaft of the implement, and the lower shaft portion formed between the attachment point of the attachment collar and the bottom of the attached blade or head. A secondary mechanical advantage is realized by deployment of the pivot stand by rotating it about the articulating joint so that it forms an obtuse angle with the support stem. The foot base is then lowered to the ground or other surface, forming a fulcrum point. The straight line distance, or moment arms, between the free end of the shaft and the fulcrum point, and a second one extending from the blade of the implement where a load is borne, to the fulcrum point. These distances depend on the combined lengths of the support stem extending from the attachment collar and the extension bar member, and the angle formed between them when the extension bar is deployed.

For digging and prying actions, the pivot stand of the instant tool provides an additional degree of freedom in the action of lifting the load on the head of the digging implement to assist the user, whereby the length of the pivot stand adds an additional translational component to the digging motion, allowing the user to lift the load by both swiveling the digging or prying head or blade upwards by rocking the shaft backward, or toward the user, to place the foot base on the ground or surface, then pivoting the shaft downward using the fulcrum formed by the foot base. This digging or prying motion engendered by the innovative design is more natural for the user than if the fulcrum point was directly on the shaft of the digging implement, that is, an articulating foot stand was not present. The user may more easily lift a load with the blade of the implement.

As a further advantage provided by the instant innovation, the foot stand may be rotated or folded so that the foot base may rest on the lower portion of the shaft of the digging or prying implement to provide an ergonomic foothold for the user to more easily push the blade or head into the ground or under a load. When the innovative leverage-enhancing attachment is deployed in this position, the digging or prying implement itself may be reengaged with the ground or a load by placing the head blade, such as the spade of a shovel or pry tool, or the tines of a digging or pitch fork of the implement on the ground or under an object to be lifted or pried, where the foot base is positioned for placement of one or both of the user's feet to assist in the penetration of the ground by the head of the digging implement, or penetration of the head of the implement into a pile or under an object to be lifted or pried upward. According to the innovation, the foothold provided by this configuration of the innovative leverage-enhancing attachment creates an ergonomic and stable foot placement, allowing the user to apply maximum bodily force to engage the implement with the ground or load comfortably, by aligning the leg with the angle of the handle and blade or tines relative to the surface or ground. This foothold geometry afforded by the instant innovation enhances the user's ability to use bodily force to press the head of the implement into the ground or to engage a load.

As a yet further advantage provided by the innovative leverage-enhancing attachment, the mechanical advantage described above is afforded while allowing the shaft of the digging or prying implement to stand with a relatively small incline from the vertical once the implement is engaged with the ground or load, providing an ergonomic lever by allowing the user to position his or her arms and hands at shoulder or upper torso level instead of lower torso or waist level in order to initiate the pivoting action to lift the load imposed on the head of the implement, for example to pivot and lift the head of a shovel out of the ground in a digging operation, or applying upward force required for a prying operation.

### BRIEF DESCRIPTION OF THE DRAWINGS

FIG. 1a. Exploded view of a first embodiment of the innovative leverage-enhancing attachment assembly.

FIG. 1b. Exploded view of a second embodiment of the innovative leverage-enhancing attachment assembly.

FIG. 1c. Exploded view of a third embodiment of the innovative leverage-enhancing attachment assembly.

FIG. 1d. View of an alternative embodiment of the foot base.

FIG. 1e. Detailed view of the attachment collar assembly, showing chamfer inside the gap of the shank.

FIG. 2. Assembled innovative leverage-enhancing attachment attached to a digging or prying implement, foot base pivoted downwards to provide an ergonomic foothold for a user.

FIG. 3a. View of the twisted embodiment of the extension bar.

FIG. 3b. View of the assembled innovative leverage-enhancing attachment, comprising the twisted extension bar embodiment pivotally affixed to the end of the unbent embodiment of the support stem of the attachment collar assembly.

FIG. 3c. Perspective view of the angled embodiment of the attachment collar assembly, comprising the two-piece collar ring.

FIG. 3d. Perspective view of abutment embodiment.

FIG. 3e. Perspective and exploded view of first alternative abutment embodiment.

FIG. 3f. Perspective and exploded view of second alternative abutment embodiment

FIG. 3g. Frontal view of second alternative abutment embodiment.

FIG. 3h. Perspective view of third alternative abutment embodiment.

FIG. 3i. Frontal view of third alternative abutment embodiment.

FIG. 3j. Frontal view of fourth alternative abutment embodiment.

FIG. 4. Perspective view of the assembled innovative leverage-enhancing attachment comprising the twisted extension bar embodiment and the two-piece collar ring embodiment.

FIG. 5a. Perspective view of a method of deployment of inventive digging and prying aid—initial part of digging stroke showing ergonomic foot placement before driving shovel blade into the ground.

FIG. 5b. Perspective view of a method of deployment of inventive digging and prying aid—mid portion of digging stroke showing extension of users leg and completion of engagement of shovel blade with the ground.

FIG. 5c. Perspective view of deployment the innovative leverage-enhancing attachment for creating of fulcrum by pivoting extension bar and foot base outward, where foot base forms the fulcrum point.

FIG. 5d. Perspective view of deployment of the innovative leverage-enhancing attachment for completion of digging stroke.

FIG. 5e. Perspective view of deployment of innovative leverage-enhancing attachment comprising the angled embodiment of the attachment collar assembly.

FIG. 6a. Side view of the innovative leverage-enhancing attachment secured on a shovel handle, foot base deployed in a support position and shovel blade engaged with ground.

FIG. 6b. Side view of the innovative leverage-enhancing attachment used to provide mechanical advantage to complete digging stroke.

FIG. 7. Force diagram showing moment arms and applied forces for derivation of mechanical advantage equations.

FIG. 8. Example of use of the inventive digging and prying tool aid—prying task in roofing application.

FIG. 9. Example of use of the inventive digging and prying tool aid—lifting a heavy object with a prying implement.

FIG. 10. Example of use of the inventive digging and prying tool aid—aid for use of a scoop shovel.

### DETAILED DESCRIPTION

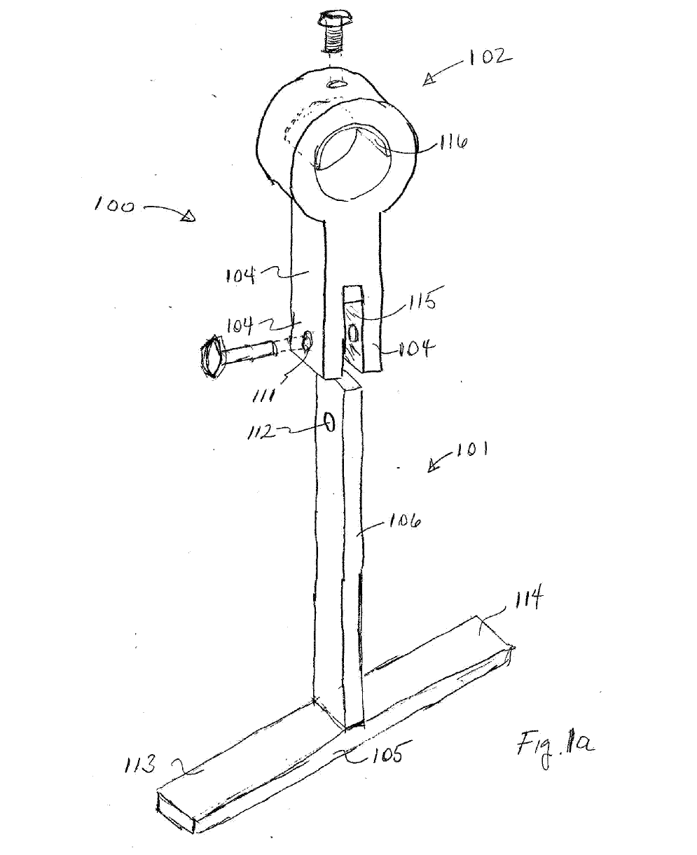

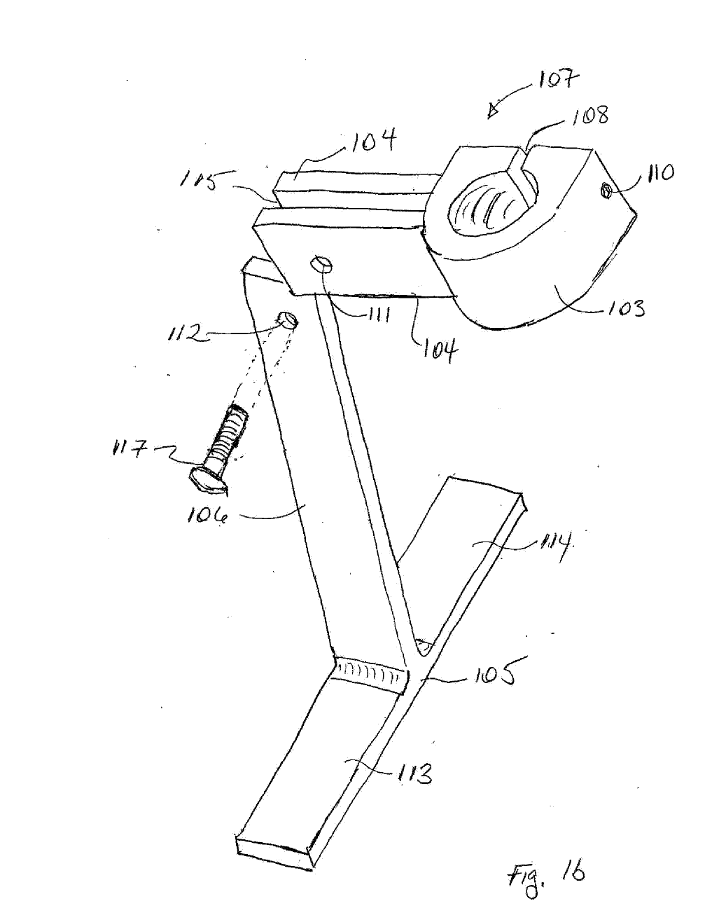

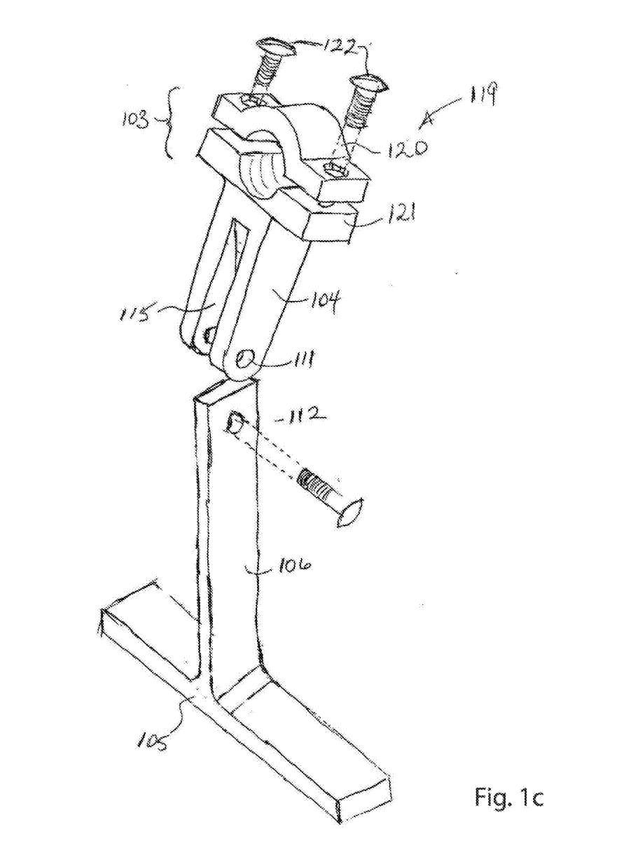

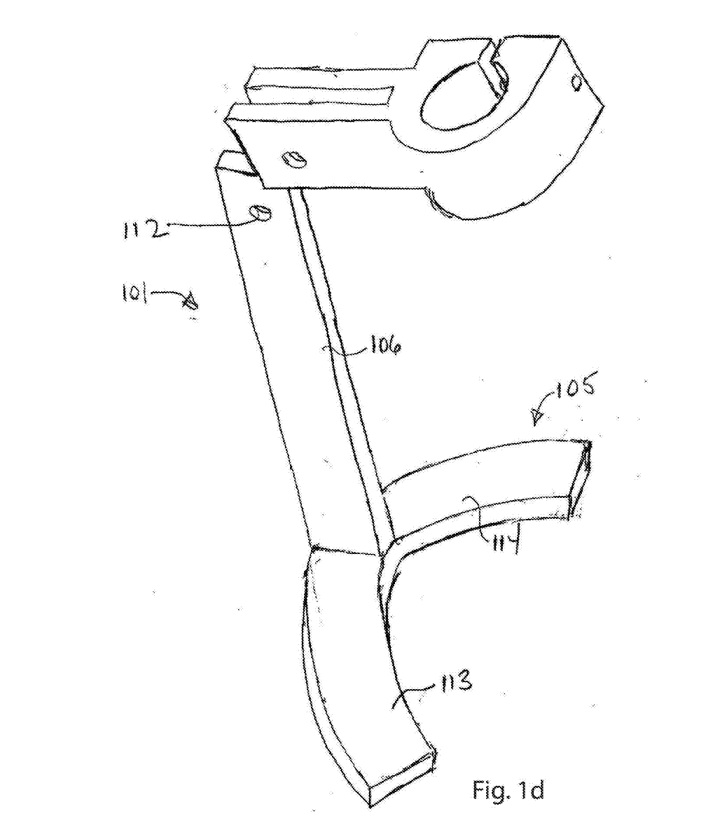

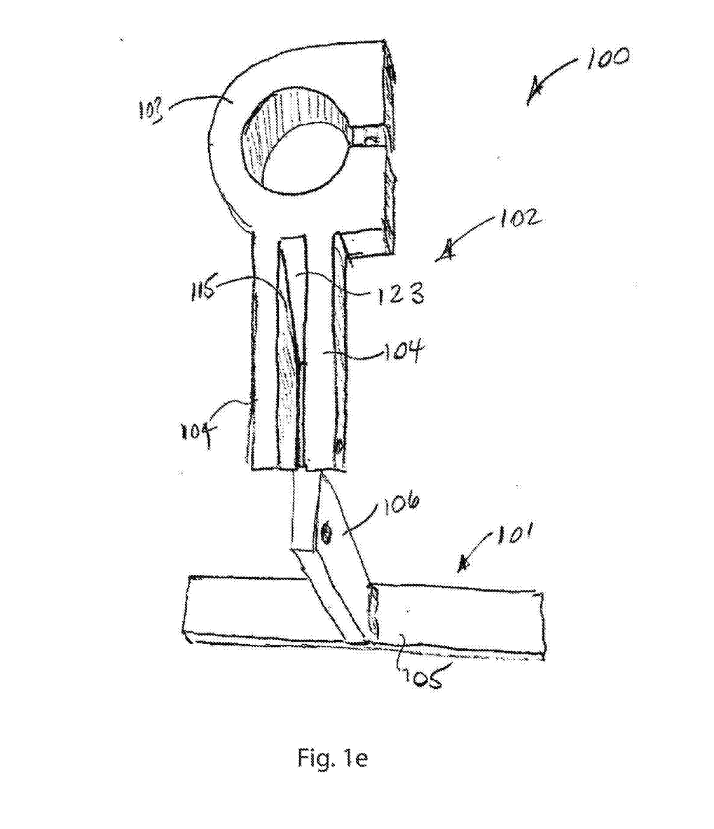

FIGS. 1a-c shows an exploded view of a basic embodiment 100 of the innovative tool disassembled. The basic embodiment comprises stand part 101 and articulating lever arm part embodiments 102 and 107.

In one embodiment shown in FIG. 1a, attachment collar 103 may be configured as a rigid contiguous ring to accommodate the shank or shaft of a digging implement, such as a digging shovel, a trenching shovel or a scoop shovel, or a prying tool, such as a pry bar or roofing shovel. The collar 103 may have a threaded bolt-hole 110 disposed on the collar body such that the axis of the bolt-hole 110 extends radially from the center of the collar, allowing a bolt to fasten the collar to a digging implement shank or shaft.

In the alternative embodiment of the innovative leverage-enhancing attachment shown in FIG. 1b as an exploded view, the attachment collar may be configured as a split ring clamp, as in the example shown in attachment collar embodiment 107, having a kerf 108 cut in the collar 103 and threaded bolt hole 110 cut perpendicular to the kerf for tightening the collar 103 around an shaft of a digging or prying implement. In both embodiments, through-hole 111 serve allow passage of a bolt or pin for fastening support stem 104 extending below attachment collar 103 to foot stand 101. Through-hole 111 mates with passage hole 112 disposed near the upper end of extension bar 106 of foot stand 101, allowing passage of a bolt or pin for pivotally fastening support stem 104 of attachment collar assembly 107 (embodiment 102 or 107) to extension bar 106. For the assembly, extension bar 106 inserts into gap 115 to allow foot stand 101 to rotate about the pivot point formed by the bolt or pin fastener. a compression ring 115 may be included to insert into collar 103 to form a compression clamp around the shank or shaft of a digging implement when bolt 116 is tightened. Bolts such as the shoulder bolt 117 may be used.

In a further embodiment 119 shown in FIG. 1c, the attachment collar 103 may be configured as a two-piece bracket clamp comprising a detachable bracket piece 120 and bottom flange 121, to which bracket piece 120 may be affixed, for example, by bolts 122. This embodiment of attachment collar 103 is adapted to clamp about the shaft of a digging or prying tool, such as a digging shovel, trenching shovel, scoop shovel, or pry bar and the like, having a hand grip, such as a D-shaped grip or handle, affixed to the top of the shaft, making it necessary to employ a split attachment collar 103 having a removable bracket piece 120 to clamp the attachment assembly 119 to the shaft of the digging or prying implement.

Referring to FIGS. 1a-c, foot base 105 of stand 101 may comprise a single bar, or two separate elements extending perpendicularly from the bottom of extension bar 106. In alternative embodiment depicted in FIG. 1d, feet 113 and 114 may be disposed in a non-collinear manner at or near the bottom of extension bar 106. For example, rods 113 and 114 may form an angle between them at their point of fixation on extension bar 106, forming a V, as shown in FIG. 1d.

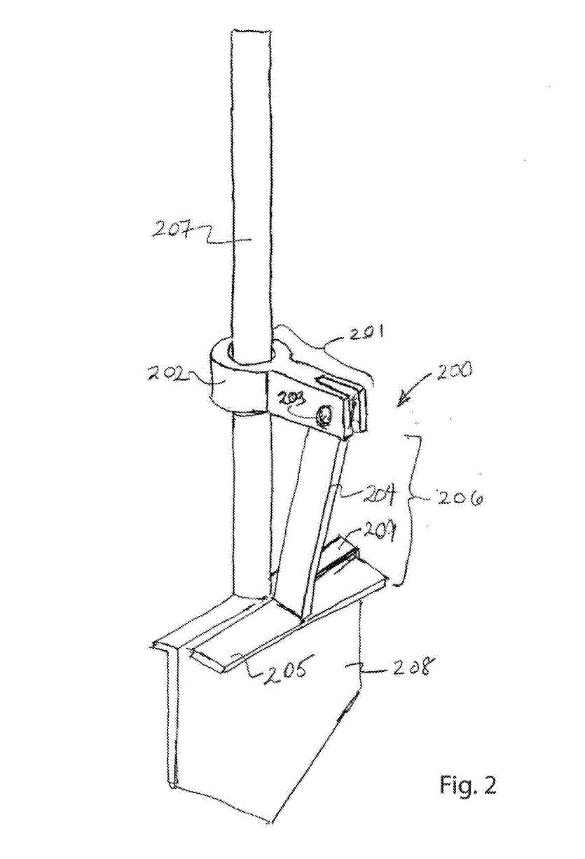

Examining lever arm 102 in greater detail in FIG. 1e, support stem 104 is at least partially split, forming gap 115 between the two lateral portions 104 descending from collar 103 and flanking gap 115. Extension bar 106 fits within gap 115 (see FIG. 2), thus the width of gap 115 is slightly larger than the width of extension bar 106. Furthermore, gap 115 may comprise an internal chamfer 120 so that when the inventive digging and prying aid 100 is folded, as described below, extension bar 106 rests on the surface of the chamfer 120 within the gap 115 of lever arm 102. The chamfered surface 120 within gap 115 may provide a stop to limit the folded angle between the pivoting portions. When the inventive digging and prying aid 100 is attached to the shaft or blade shank of a digging implement, as described below, extension bar 106 may be folded downwards to rest against the chamfered surface within gap 115, forming a stable foot placement, whereby the laterally-extending rods or bars 113 and 114 of foot base 105 may provide a substantial and strong foothold upon which the user of the digging implement may place his or her foot and apply bodily force more efficiently to push the blade into the ground or pile.

In FIG. 2, an assembled view of the collar ring embodiment of the innovative leverage-enhancing attachment 200 is shown mounted on a shovel handle. Attachment collar assembly 201 is affixed at one end to the elongated shovel handle, and forms an articulating joint with extension bar 202 by virtue of a bolt, pin or bushing extending 203 though mating holes (111 and 112 of FIG. 1). In most embodiments, attachment collar assembly 201 may be rigidly affixed to the blade shank or shaft of a digging or prying implement, allowing extension bar 204 to pivot freely. Lower portion 205 of the innovative leverage-enhancing attachment, which comprises extension bar 204 and foot base 205 (can be a single rod or bar attached to the bottom of extension bar 204), may be pivoted downwards so that foot base may abut or rest against handle 207 or blade 208. In this position, foot base 205 provides a footrest platform for the user of the digging or prying implement to step upon and press or drive the blade with the foot into the ground, pile or under an object to be lifted or pried.

Foot base 205 provides a foothold that has a wide surface for the user upon which to ergonomically place his or her foot, rather than on the top edge 209 of the blade 208, which is the conventional alternative for these types of tools. Top edge 209 may provide a thin ledge or lip for foot placement, which limits the amount of bodily force the user may apply with the foot to drive the blade into the ground or under an object to be pried, whereas foot base 205, having a wide surface, allows more secure foot placement so that the user may use bodily force more efficiently. Moreover, foot base 205 may provide sloped surface for foot placement, where the slope angle may be adjusted so that the user's foot may be aligned with this angle, causing the leg to be aligned to a more natural angle to transfer greater bodily force to the blade.

Once the blade of the digging implement has been engaged with a load, base 205 of the inventive digging and prying aid 200 may be pivoted outwards by using the foot or hand to a deployment position. In the deployment position, base foot 205 may be placed in contact with the ground, and provide a stable and fixed footing for the pivoting of the attachment collar assembly 206 about the articulating joint formed with attachment collar assembly 201 affixed to the digging implement handle 207. The pivot point provides a fulcrum about which attachment collar assembly 201 may swing, allowing the user to rotate the blade of the implement with its load upwards. This is explained in greater detail below. The mechanical advantage afforded by the inventive digging and prying aid is obtained by the relative lengths of attachment collar assembly 201 and extension bar 204, as well as the relative lengths of the digging implement handle above and below the attachment point of attachment collar assembly 201 on the handle.

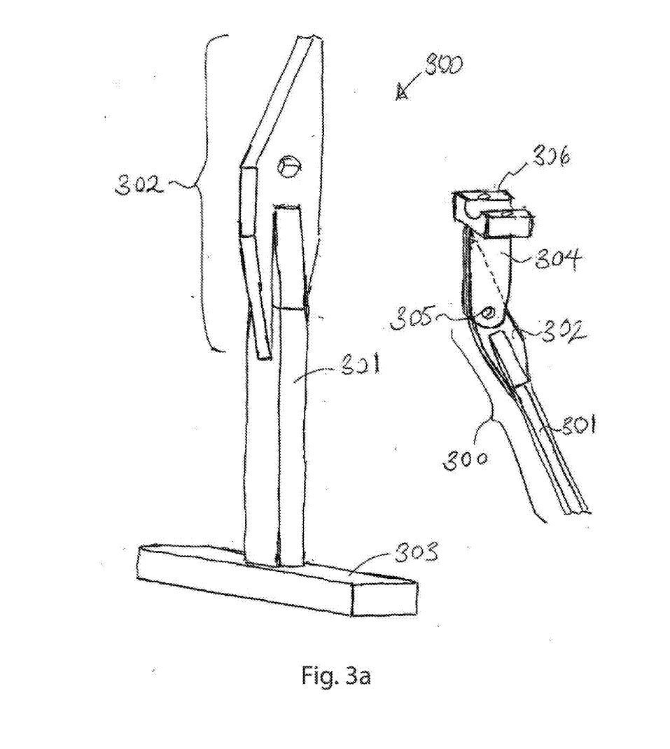

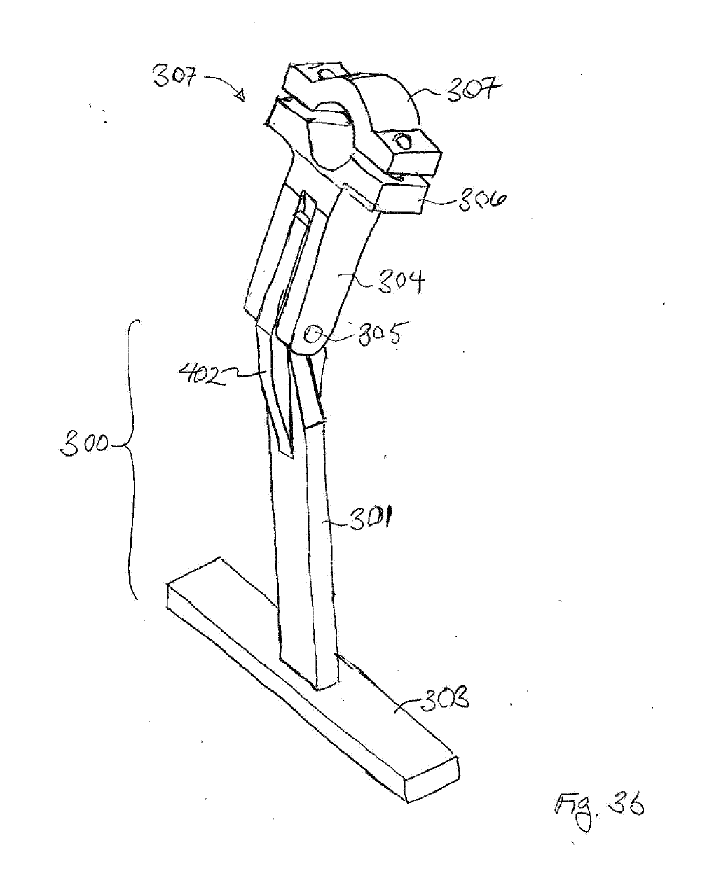

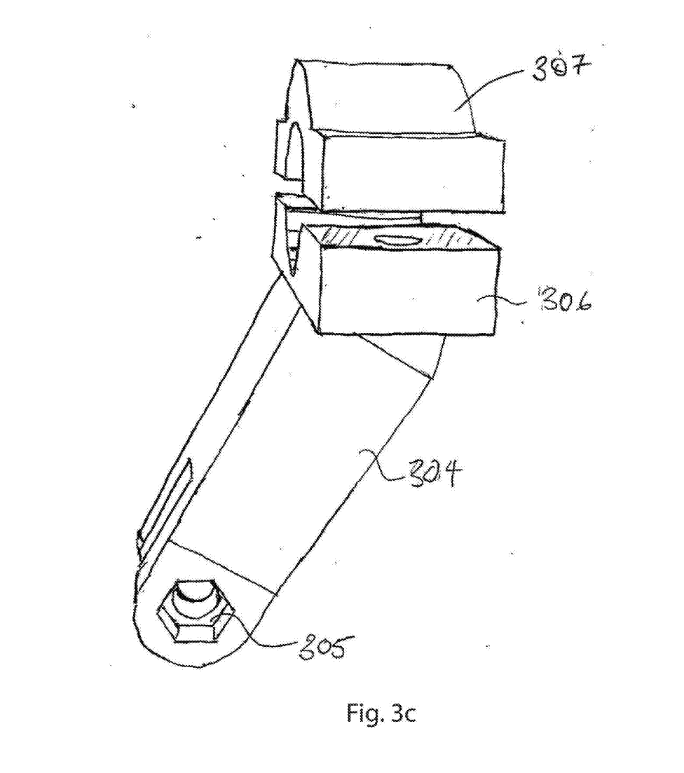

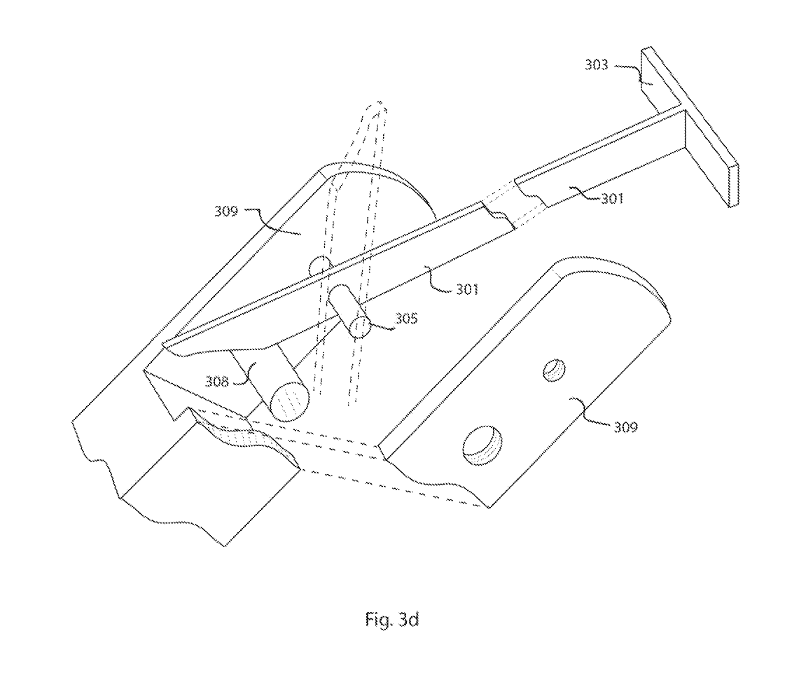

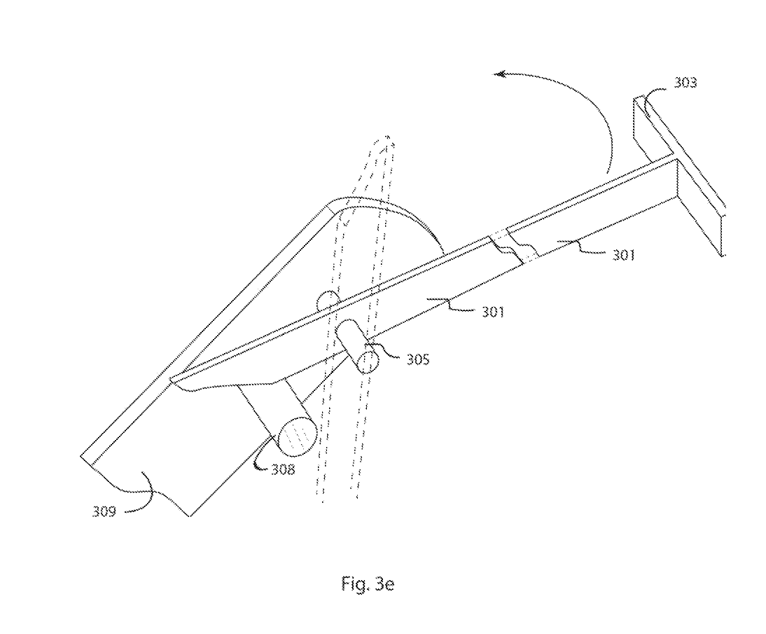

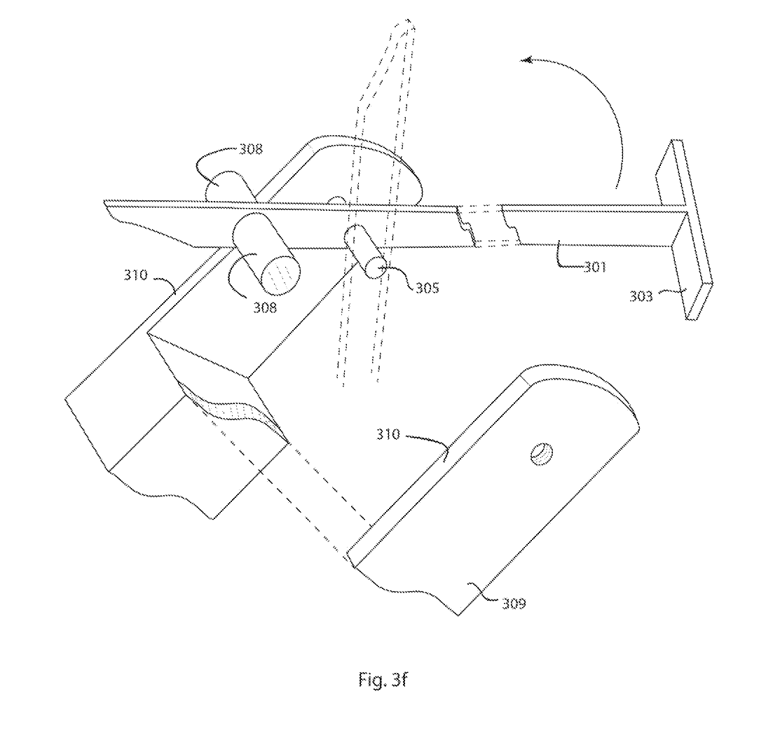

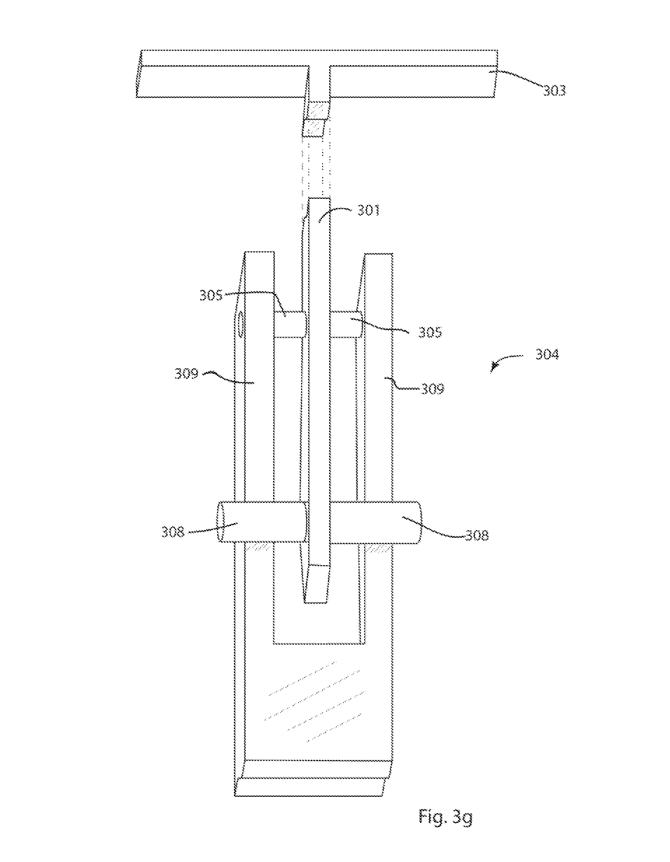

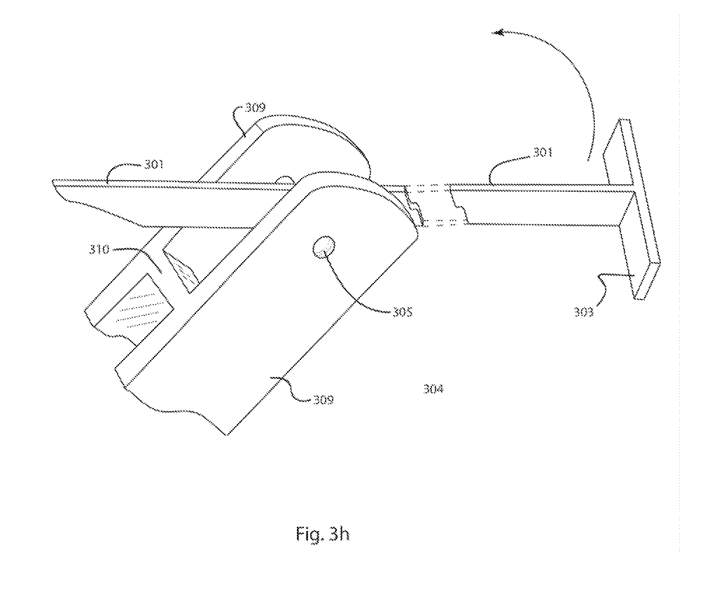

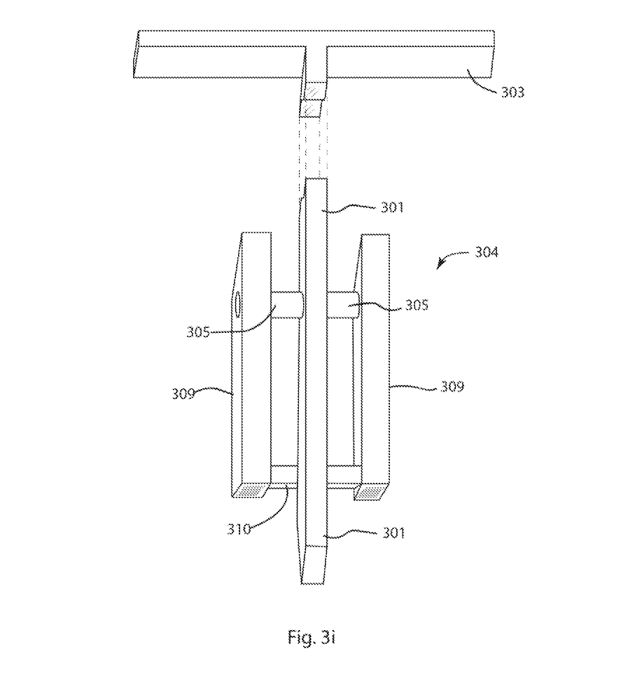

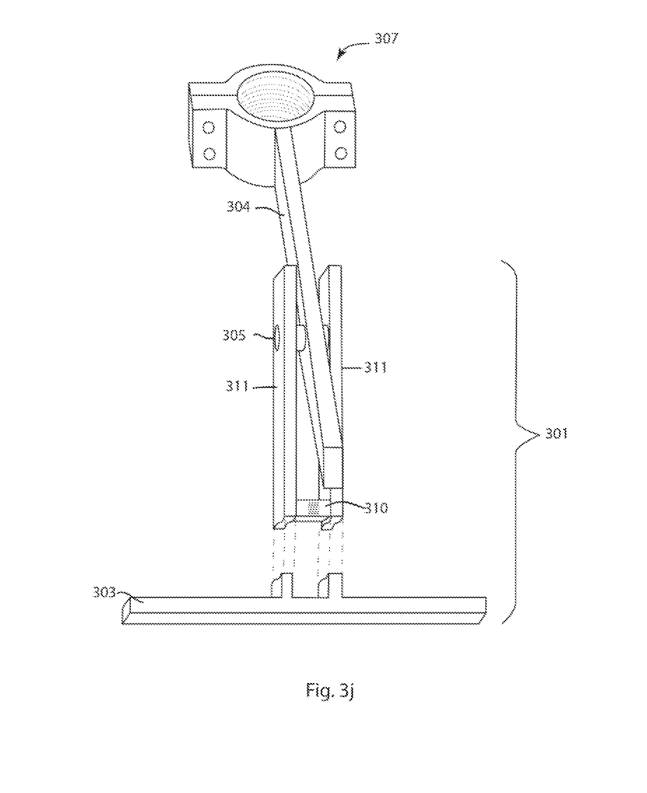

Another embodiment of the digging and prying aid is shown in FIG. 3a. In this embodiment, leg 300 is twisted, substantially at a 90° angle along its axis in this example. Extension bar 300 may now comprise a lower portion 301 and an upper portion, 302, shown as an angled plate affixed to lower portion 301. Lower portion 301 of extension bar 300 may have a high aspect ratio rectangular cross section as shown in FIG. 3a whereby the thickness is smaller than the width, and may join base foot 303 with the wide dimension aligned with that of base foot 303. This arrangement may impart greater stability to the innovative aid during use relative to the previous embodiment.

The inset of FIG. 3a shows upper portion 302 of extension bar 300 inserts into the gap (not shown but essentially described above and in FIG. 2) of attachment collar support stem 304 and abuts the chamfer extending diagonally between the two lateral portions into the gap in support stem 304 from the base of flange 306 along one edge, as shown in FIG. 1e and FIG. 2, in order to restrict the pivot angle of leg 300. Upper portion 302 may be pivotally affixed to support stem 304 by a bolt or pin inserted through passage hole 305, disposed in attachment collar support stem 304, providing a pivot point for leg 300. The inset of FIG. 3a shows that leg 300 may be caused to extend at an angle relative to the axis of support stem 304 as a result of the abutment of upper portion 302 against the chamfer existing in the gap between lateral portions of support stem 304. In the present embodiment, the combined angle in the inserted piece 304 and that of the chamfer existing in the gap ultimately determines the angle formed between extension bar 300 and attachment collar 305 when extension bar is fully extended.

An example is shown in FIG. 3b, where leg 300 is extended downward from attachment collar 307 to the point where the angled edge of upper piece 302 rests on chamfer 306, stopping leg 300 from pivoting outward any further. Thus, a fixed angle is formed between leg 300 and attachment collar 307 when leg 300 is pivoted outward to the deployment position. This fixed angle may be optimized to provide the largest ergonomic advantage to the user. Inclusion of this small angle causes the leg to extend at an angle less than 90° from the implement shaft, causing the implement shaft to be less inclined and tilted more vertically when the leg is deployed and the blade is engaged. The more vertical the handle of the digging implement, such as a shovel, is in relation to the ground, the easier it is for the user to pivot the implement handle because the user's arms are more at chest or shoulder level.

In FIG. 3c, a bent embodiment of attachment collar is shown. Support stem 304 extends downward from the base flange 306 of the collar ring at an angle. In this embodiment, the pivot joint between the leg and support stem 304 may be straight. In FIG. 3d, another embodiment of the innovative digging and prying aid is shown, where the pivot stand 300 is depicted comprising a bar pivotally affixed to attachment collar support stem 304 via pin or axle 305. An abutment 308 is provided in this embodiment, where abutment 308 is affixed to attachment collar support stem 304 so that extension bar 301 may abut against it when pivot stand 300 is extended. A variation is shown In FIG. 3e, where attachment collar support stem 304 shown in an exploded view is forked as in earlier embodiments. Stand 300 pivots between lateral portions 309 extending from attachment collar base by means of pin or axle 305 that may extend between the two lateral portions 309. In this embodiment, abutment 308 extends within the gap between lateral portions 309. When rotated upwards as indicted by the curved arrow in FIG. 3e, extension bar 301 butts against abutment 308 and can pivot no further, where stand 300 is deployed in the fully extended position.

Another variation of the abutment embodiment is shown in FIG. 3f, where forked attachment collar support stem 304 shown again in an exploded view. Stand 300 pivots between lateral portions 309 by means of pin or axle 305 that may extend between the two lateral portions 309. In this embodiment, abutments 308 are affixed to and carried by extension bar 301. When pivot stand 300 is extended, abutments 308 butt against edges 310 of lateral portions 309, limiting the pivotal angle of pivot stand 300 and allowing the extended stand 300 to be fixed in a secure position when extended. When rotated in the opposite direction, pivot stand 300 may be freely rotated to rest foot base 303 against the digging or prying implement shaft (not shown). FIG. 3g shows a frontal view of the embodiment shown in FIG. 3f.

A yet further embodiment of the abutment embodiment is shown in FIG. 3h, where a single abutment is incorporated in the structure of support stem 304. In this simple form, extension bar 301 may butt against the edge of gap base 310 when pivoted downward as indicated by the curved arrow in FIG. 3h. FIG. 3i shows a frontal view of the embodiment of FIG. 3h. A different embodiment is depicted in FIG. 3j, where the member structures are reversed. In this embodiment, pivot stand 301 now comprises lateral portions 311 separated by a gap in which pivot axle or pin 305 extends from one side to the other. Abutment 310 may be disposed within the gap as well, as shown in the example of FIG. 3j. Support stem 304 comprises a single bar or piece extending from attachment collar 307. An articulating joint is again formed between pivot stand 301 and support stem 304 by means of axle 305. As with the above embodiments, abutment 310 is provided to limit the pivot angle of pivot stand 301 during its deployment. Abutment 310 may also be disposed on support stem 304 as shown in FIGS. 3f and 3g.

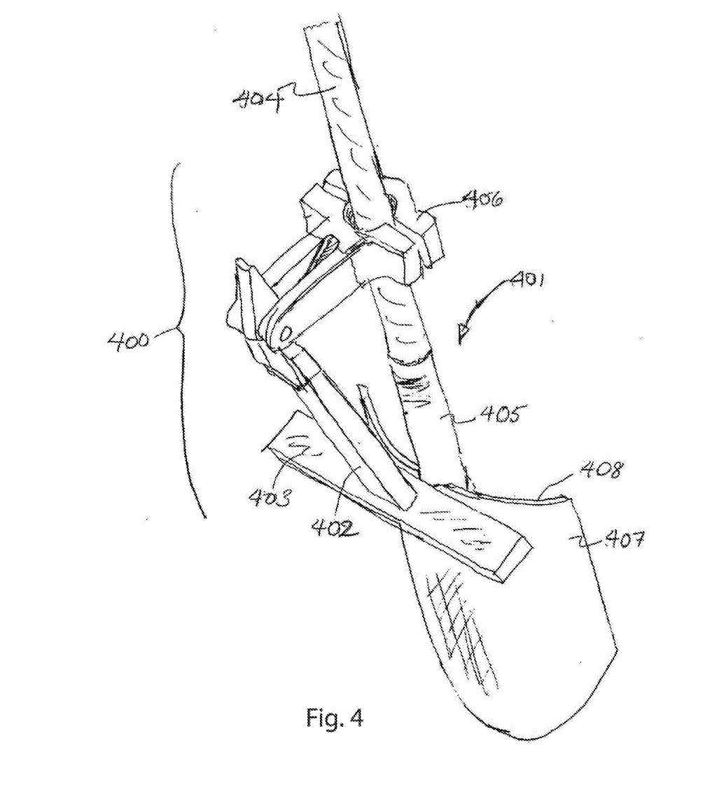

An example is shown in FIG. 4 of use of the twisted leg embodiment 400 just described where the leg is pivoted inwardly, out of the support position, and rests against the implement handle or blade. Innovative aid 400 is shown affixed to shovel 401. The length of leg 402 may be set so that when pivoted inward, foot base 403 may rest against shovel handle 404 or blade shank 405, as shown in FIG. 4. To maintain an ergonomic advantage, the attachment point of collar 406 may be set in the lower portion of shovel handle 404, just above blade 407. For optimal deployment and use of the innovative aid 400, the length of leg 402 may be optimized so that foot base 403 may rest on shovel handle 404 just above the top of shovel blade 407, or just at the top of blade 407. When preparing to engage shovel blade 407 with the ground, a user may engage a foot on foot base 403, which is stably supported against handle 404 or blade 405.

As seen in FIG. 4, foot base 403 provides a relatively wide surface for foot placement, which moreover may be ergonomically sloped or angled to allow the user to apply maximum bodily force when pressing the foot downward to force blade 407 into the ground. This detail is accomplished by providing a sloped foot-engagement surface such that the user may comfortably position his or her leg for pressing downward on the foot. FIG. 4 also shows that for conventional use of a shovel, the user normally places his or her foot on the top edge 408 of blade 407. Edge 408 may be narrow, providing minimal surface for foothold. The user's foot may slip off the blade in cases where the sole of the user's shoe is wet or mud-covered.

Moreover, the user may be obliged to incline the blade 407 and handle 404 at a shallower angle in order to align the user's leg with the shovel axis in order to transfer maximum force to the point of blade 407. Handle 404 is inclined closer to the ground in this case, and as mentioned above, this position is not ergonomic for the user. The provision of an ergonomic foothold by the innovative aid for the user may eliminate these disadvantages, allowing shovel handle 404 and blade 407 to assume a steeper angle of attack. First, the handle 404 is tilted away from the ground allowing more ergonomic manipulation of the shovel (or prying tool) by a user. Blade 407 is also positioned to engage with the ground at a steeper angle of attack, which allows for a more efficient digging stroke as greater volume of earth may be dug or scooped out per stroke. Second, an additional advantage is provided by the innovative aid, where the bodily force applied by the user to foot base 403 is transferred to handle 404 itself by virtue of attachment collar 406. The user's bodily force is then transferred down handle 404 to the central portion of blade 407, focusing the force at the tip or attacking edge of blade 407. A greater concentration of force at the tip of blade 407 allows for more efficient distribution of the bodily force applied by the user when engaging blade 407 with the ground, as the bodily force is more concentrated at the tip of blade 407 to more easily push it into the ground.

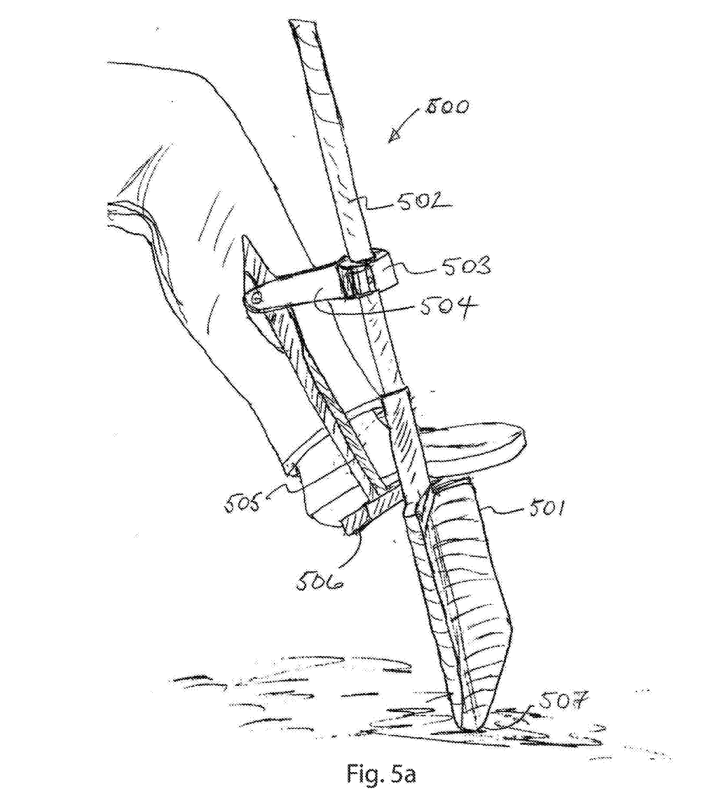

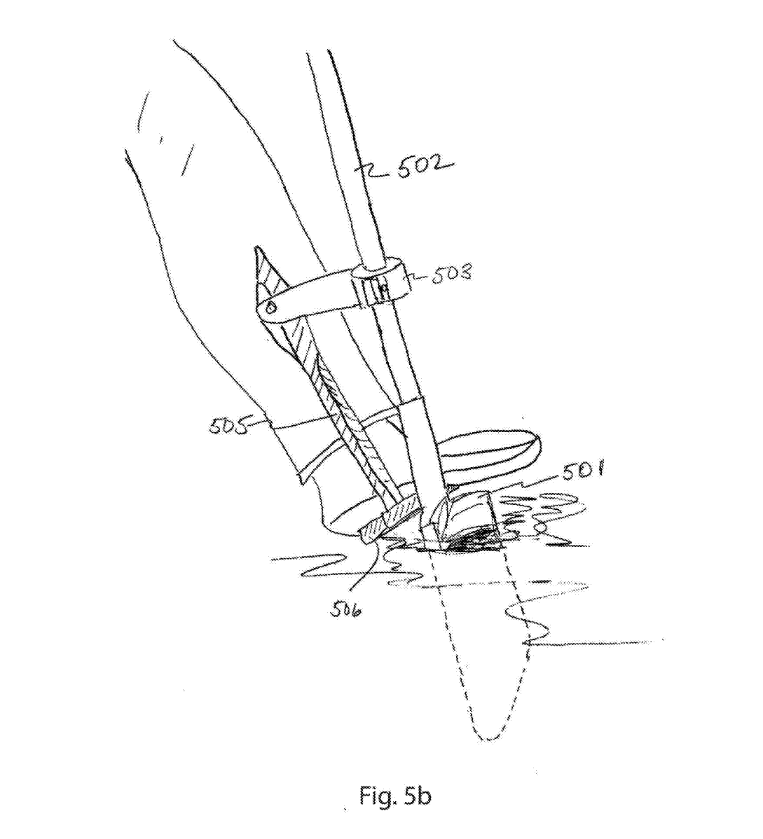

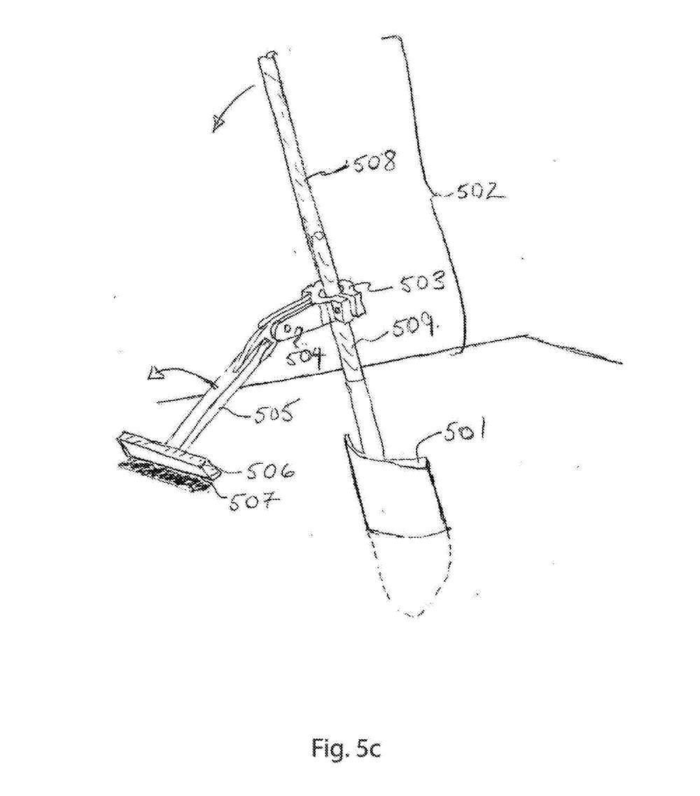

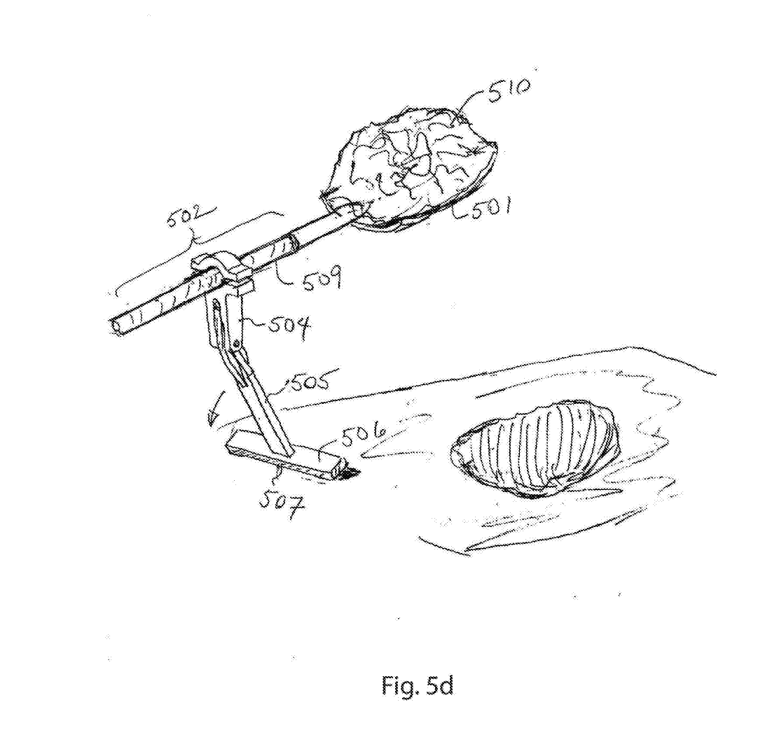

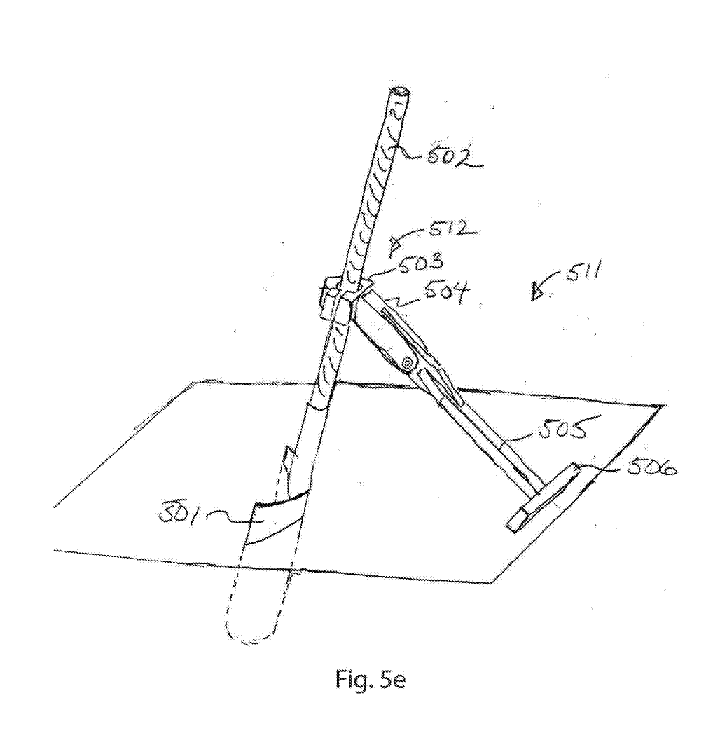

A sequence of deployment positions of the inventive digging and prying aid is shown in FIGS. 5a-e. FIG. 5a depicts a view a user preparing to dig a hole in the ground with shovel 500 equipped with the inventive digging and prying aid (shown by parts assembly 303-306), by engaging blade 301 of spade The inventive digging and prying aid is shown attached to the shaft 502 of shovel 500 by attachment collar 503. By way of example, attachment collar support stem 504 is depicted extending at a perpendicularly from attachment collar 503, and therefore is also perpendicular to shovel handle 502. The perpendicular angle is by no means meant to be limiting, and it will be recognized by those skilled in the art that any convenient angular relationships may be employed amongst the various components of the innovative digging and prying aid and the digging implement. An example is shown below using the bent embodiment of the attachment collar assembly.

Extension bar 505 is depicted as being pivoted and folded downward in a pre-deployment position, and may be stopped at a particular angle by resting against chamfer 120 within gap 115, as introduced in FIG. 1e, or may have no internal constraint, and simply be pivoted until foot base 506 is brought to rest against shaft 502. Because it is attached to the handle of the shovel, a great advantage is gained by transferring a downward force from the leg to the center of the shovel shaft increasing the net force on the tip or cutting edge 507 of the shovel blade 501. Moreover, the tendency to cause the blade and handle to tip sideways when, in conventional use, the user applies force to the one side of the top edge of blade 501.

In this pre-deployment position of the inventive digging and prying aid, foot base 506 provides a foothold for the user to place a foot to apply downward force, aiding in plunging blade 501 into the ground. By virtue of the angle of the foothold surface of foot base 506, and the placement of the foothold at the top of blade 501 the user is better able to engage the quadriceps muscles of the thigh more efficiently because the user's leg is aligned with extension bar 505. The user may extend her or his leg, thereby transferring greater downward force to the blade without causing the user to rock forward to apply more leg force needed to drive the blade into the ground, which would be the case without use of the innovative aid. At the same time, shovel handle 502 may remain substantially upright, forming a near-vertical or steep angle with the ground. This is illustrated in FIG. 5b. A near-vertical, upright, or steep angle of handle 502 allows for more ergonomic geometry for manipulation of the shovel, as explained above in relation to position of arms and hands during the digging (or prying) operation. The innovative aid permits the user to maintain the handle 502 substantially upright while at the same time allowing the user to fully extend her or his leg in order to apply maximum bodily force while driving blade 501 into the ground.

Without the advantage provided by the innovative aid, the user is forced to rock forward in order to apply maximum force by extending the leg while at the same time maintaining the handle as vertical as possible. It should be noted that engaging blade 501 into the ground at a steep angle allows for more efficient digging, as a greater volume of earth may be removed with each digging stroke. Without the aid of the innovation, the user would need to angle the shovel (blade 501 and handle 502) at a larger incline relative to the ground in order to align the user's leg with blade angle, permitting the user to extend his or her leg to drive the blade into the ground without rocking forward. As a first disadvantage, the handle 502 is lower to the ground, and presents a less ergonomic geometry for the user to pivot the handle to finish the digging stroke. Secondly, the volume scooped out by blade 501 is less, making for a less efficient digging operation. Much of this line of reasoning applies to implements designed for prying operations.

In FIG. 5b, blade 501 has been plunged into the ground and is engaged. FIG. 5c demonstrates how the innovative leverage-enhancing attachment 507 may be deployed. Extension bar 505 is pivoted away from shovel handle 502 extend therefrom to a deployment position, where it provides a stationary upright stand by virtue of foot base 506 now resting on the ground. When deployed as shown in FIG. 5c, the user may apply force at the top of shovel handle 502 to pivot the shovel about a fulcrum point formed by the lower edge of foot base 507, as indicated by the curved arrow. The portion of the shaft above the attachment collar 503 is the upper shaft portion 508, and below attachment collar 503 is lower shaft portion 509. As will be explained below, the relative lengths of portions 508 and 509, together with lengths of parts 504 and 505 that pivot about fulcrum point 507 of the innovative leverage-enhancing attachment, provide a mechanical advantage aiding the user. The innovative leverage-enhancing attachment affords the user substantially less effort in carrying out a digging or prying task in proportion to the mechanical advantage it provides.

In FIG. 5d, shovel handle 502 is shown having been tilted downward, lifting blade 501 with load 510 out of the ground by rotating shovel 300 about fulcrum point 507. In FIG. 5e, the innovative aid embodiment 511 employing the angled (bent) attachment collar assembly embodiment 512 is affixed to shovel handle 502. Details of this embodiment are given above and an illustration is shown in FIG. 3c. In this embodiment, an angle is introduced at the junction of collar flange 503 and attachment collar support stem 504. The angle of the pivot joint formed between extension bar 505 and attachment collar support stem 504, may be substantially 180° when leg 505 is fully extended into a deployment position, as shown in FIG. 5e. In the example depicted in FIG. 5e, attachment collar support stem 504 forms an acute angle with shovel handle 502, allowing leg 505 to fully extend in a collinear fashion with attachment collar support stem 504. When leg 505 is deployed, the acute angle formed by the bend in attachment collar assembly 512 draws foot base 506 closer to handle 502, causing handle 502 to stand at a more erect angle than would be the case if no bend was present anywhere along the line extending from the attachment point on shovel handle 502 to foot base 506. Blade 501 is also tilted to a more vertical angle when engaged in the ground, and poised to scoop out a greater volume of earth when tilted upward during the digging stroke.

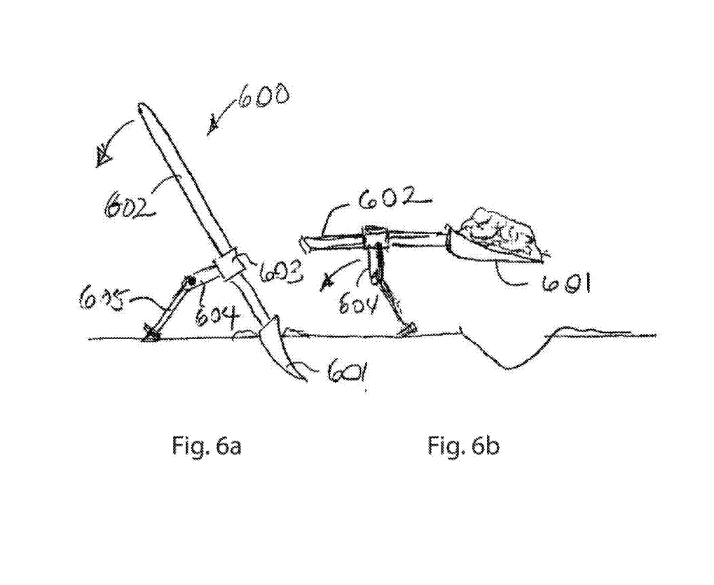

Another sequence is shown in FIGS. 6a and 6b, showing a side view of digging implement 600 equipped with the inventive digging and prying aid affixed to shaft 602 at a point where a lower portion of shaft 602 of length c extends below the attachment point, and an upper portion of shaft 602 of length a extends above the attachment point, where a>c. Blade 601 is engaged in the ground. The inventive leverage-enhancing attachment is affixed to shaft 602 by attachment collar 603, with attachment collar support stem 604 extended at a right angle from shaft 602. Shaft 602 is initially tilted at an angle θ with respect to the vertical. Pivot stand 605 is shown in the deployment position, where it is substantially inclined relative to the ground. The angle formed between attachment collar support stem 604 and pivot stand 605 is φ. In FIG. 6b, shaft 602 is pivoted downward by the user with a force of F₁, causing blade 601 to be pried or lifted out of the ground, carrying load 606 imposing an initial resistive force of F₂, comprising both the weight of the load of earth being dislodged, and frictional forces involved with dislodging the load of earth by blade 601. The initial force may the largest encountered during the digging stroke. Extended support stem 604 and pivot stand 605 comprise a lever assembly.

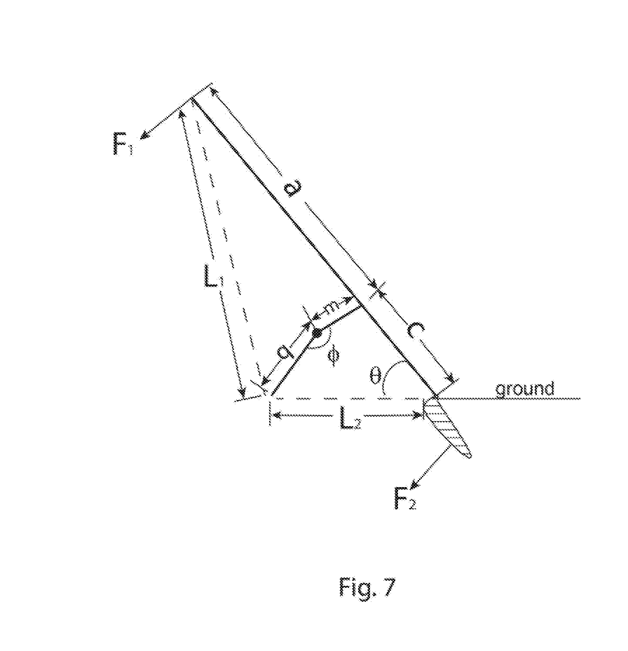

It may be shown analytically that the inventive digging and prying aid provides an enhanced mechanical advantage over conventional use of a digging or prying implement, where a simple lever comprising both blade 601 and shaft 602 is normally created with a fulcrum point at the intersection of blade 601 with the surface of the ground. Based on the schematic diagram shown in FIG. 7, and referring to FIGS. 6a and 6b, it may be shown that the mechanical advantage (M.A.) depends in a complex way upon independently adjustable length parameters a, c, m, q and independently adjustable angle φ, where a is the length of upper portion of shaft 602, c is the length of lower portion of shaft 602, m is the length of attachment collar support stem 604, a is the length of pivot stand 605 and φ is the angle between attachment collar support stem 604 and pivot stand 605 when the latter is deployed, forming the lever assembly. The mechanical advantage may be expressed as implicit functions ƒ(x) of the afore-mentioned parameters by Equation 1, which has been derived for the geometry shown in FIG. 7:

$$M . A . = \frac{{F}_{2}}{{F}_{1}} = \frac{{L}_{1}}{{L}_{2}} = \frac{f ( a , m , q , ϕ )}{f ( c , m , q , ϕ )} \qquad ( 1 )$$

where ƒ(c, m, q, φ) and ƒ(a, m, q, φ) are complicated functions of the arguments, and are given explicitly in the appendix that follows. F₂ is necessarily greater than F₁.

The mechanical advantage is the ratio of the force F₂, comprising the weight of load 606, and the applied force F₁, expressing then an amplification of the force F₁ applied by the user to lift load 606. Mechanical advantage is also expressed as the ratio of the two moment arm lengths, L₁ and L₂, where L₁ is the moment arm length extending from the top of shaft 602 to the fulcrum point formed by the foot base 607 on the ground, and L₂ is the moment arm length extending from the top of blade 601 to the same fulcrum point. This is shown in FIG. 7. F₁ multiplied by moment arm L₁ is the torque necessary to balance the torque composed of F₂ multiplied by moment arm L₂ about the fulcrum point, in order to overcome the load weight and frictional forces resisting dislodging the load 606. Thus, F₁ is the minimum required applied force. The initial tilt angle θ of the shaft 602 may be shown to be related to the length c, m, q and angle φ by the following relation:

$$θ = \frac{π}{2} - arctan [ \frac{c - q sin ( π - ϕ )}{m + q cos ( π - ϕ )} ] \qquad ( 2 )$$

Equations 1 and 2 show that the initial mechanical advantage depends in a complex way on the segment lengths as well as the lengths m and q of the attachment collar support stem 604 and extension bar 605, respectively. More simply, the mechanical advantage afforded by the innovative leverage-enhancing attachment may be maximized by optimizing the independently adjustable parameters. Equations (1) and (2) are approximate because the weight of the digging implement by itself also causes a smaller second torque about the pivot point or fulcrum. For the purposes of this disclosure, the smaller torque due to the weight of the implement itself can be neglected in comparison to the weight of load and the resistance encountered by lateral forces when lifting the blade.

### Application as a Prying Implement Aid

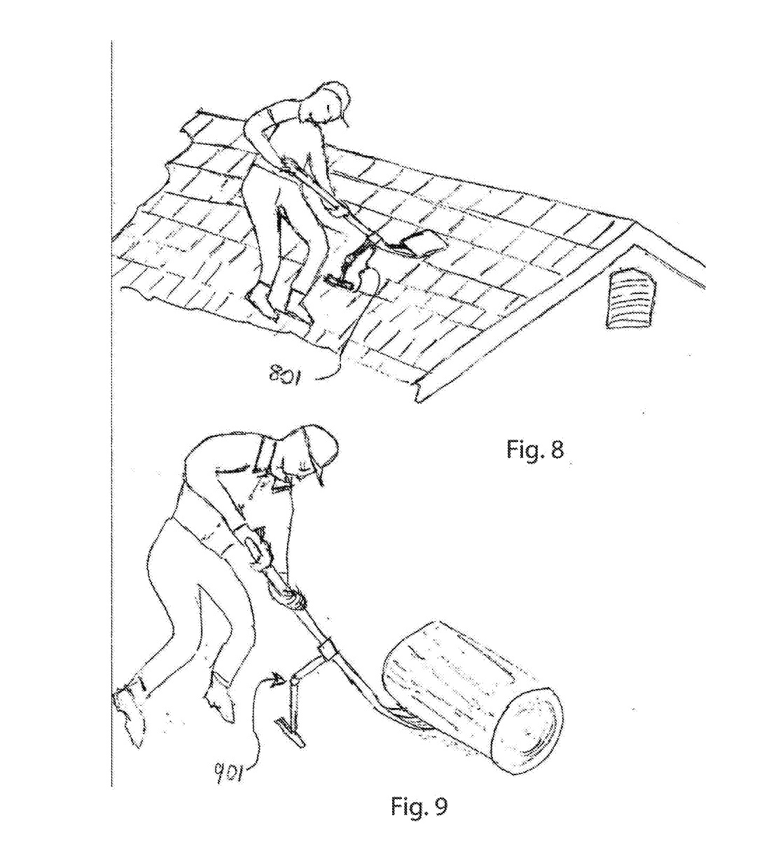

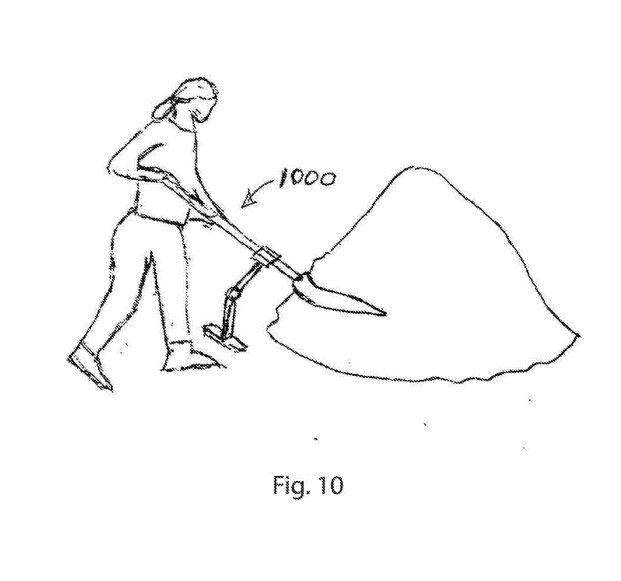

The innovative leverage-enhancing attachment may also be applied effectively to aid prying tools, such as roofing shovels and pry bars. The same principles described above for digging applications apply to prying implements. FIG. 8 depicts roofing shovel equipped with the innovative leverage-enhancing attachment 801. In a related application, a prying implement used for lifting heavy objects also benefit from the innovative leverage-enhancing attachment, as shown in FIG. 9. The instant aid may also be employed to assist scooping tasks, such as snow shoveling or scooping gravel or coal. This is depicted in FIG. 10, where the instant leverage-enhancing attachment is depicted attached to a scoop shovel 1000.

The foot base may be studded on the top and bottom surfaces to increase grip of the sole of the user's shoe and prevent slippage, as well as to anchor in the ground to prevent slippage and increase stability.

### Example of Method of Use

An example of deployment and use of the innovative leverage-enhancing attachment is described as follows. The aid is attached to the shaft of a digging or prying implement by means of any of the embodiments described for the attachment collar. With the pivot stand pivoted downwards in the pre-deployment position, the tip of the blade of the implement is poised for engagement. The user may then place his or her foot on the top side of the foot base, and press with his or her foot and extend his or her leg to drive the blade of the digging or prying implement into the ground or pile, or under an object to be lifted or pried. The user then may kick or otherwise move the pivot stand outward away from the elongated shaft and blade, extending the pivot stand to its pivot limit, which for instance may occur when its top portion abuts with an angled chamfer in the gap formed in the support stem. The extended pivot stand and the support stem thus form a lever assembly. The foot base is then made to rest on the ground or other surface, so the shaft of the implement is supported. The user then may apply a downward force with his or her arms to the top portion of the shaft of the digging or prying implement to cause it to pivot downward thereby pivoting the blade upwards, carrying a load, by rocking the lever assembly toward the user on the fulcrum point formed by the foot base, where the combined support stem and pivot stand form a rigid support as well, allowing the implement to remain horizontal as shown in FIG. 5d.

The embodiments described in this application are exemplary, and by no means limit the innovation described herein. It will be understood by those skilled in the art that other variations of the embodiments described are also considered without departing from the scope of the innovation described herein, and claimed in the claims that follow.

### APPENDIX

It can be shown that the lengths of moment arms L₁ and L₂ according to the diagrams in FIGS. 6 and 7 may be expressed by the following equations:

$${L}_{1} = \frac{q sin ( π - ϕ )}{sin ϕ} + \sqrt{\{ {a}^{2} + {[ m + q cos ( π - ϕ ) - q \frac{sin ( π - ϕ )}{sin ϕ} sin [ {cos}^{- 1} ( sin ϕ ) ] ]}^{2} \}}$$

$$and$$

$${L}_{2} = \frac{m + q cos ( π - ϕ )}{cos \{ {tan}^{- 1} [ \frac{c - q sin ( π - ϕ )}{m + q cos π - ϕ} ] \}}$$

where independent parameters a, c, m, q and φ are defined above.

1. An aid for the action of digging, shoveling and prying, comprising:
(i) a collar having a base, said collar adapted to clasp about the shaft of a digging or prying implement;
(ii) a support stem affixed to the base of said collar, and extending therefrom along an axis, said support stem having at least one abutment disposed thereupon; and
(iii) a pivot stand pivotally affixed to the support stem and forming an angle therebetween, said stand extending from the pivot joint to terminate at a foot base,
wherein the pivot stand abuts against the at least one abutment disposed upon the support stem when the pivot stand is rotated to increase the angle formed between the support stem and the pivot stand.

2. The aid for the action of digging, shoveling and prying of claim 1, wherein the support stem comprises a forked body having two lateral portions separated by a gap, the two lateral portions extending in parallel from the base of said attachment collar flanking the gap.

3. The aid for the action of digging, shoveling and prying of claim 2, wherein the at least one abutment comprises a chamfer extending from the base of the attachment collar into the gap between the two lateral portions of the support stem.

4. The aid for the action of digging, shoveling and prying of claim 1, wherein the support stem comprises a solid bar.

5. The aid for the action of digging, shoveling and prying of claim 1, wherein the pivot stand comprises a forked body having two elongated lateral portions extending in parallel from the foot base, a pivot joint being disposed along the two lateral portions.

6. The aid for the action of digging, shoveling and prying of claim 1, wherein the pivot stand comprises a forked body having two lateral portions extending in parallel from the foot base and having a gap therebetween, said gap receiving a portion of the support stem that is adapted to pivot within the gap, forming a pivot joint with the pivot stand, that is disposed along the two lateral portions, wherein the support stem is pivotally affixed to the pivot stand.

7. The aid for the action of digging, shoveling and prying of claim 1, wherein the support stem comprises a forked body having two lateral portions separated by a gap, the two lateral portions extending in parallel from the base of said attachment collar flanking the gap, said gap receiving a portion of the pivot stand that is adapted to pivot within the gap, forming a pivot joint with the support stem that is disposed along the two lateral portions, wherein the pivot stand is pivotally affixed to the support stem.

8. The aid for the action of digging, shoveling and prying of claim 1, wherein the attachment collar comprises a contiguous ring that encircles the shaft of the digging implement.

9. The aid for the action of digging, shoveling and prying of claim 1, wherein the attachment collar comprises a split ring clamp.

10. The aid for the action of digging, shoveling and prying of claim 1, wherein the attachment collar comprises a two-piece bracket, comprising a detachable bracket piece and a flange base affixed to the end of the support stem.

11. The aid for the action of digging, shoveling and prying of claim 1, wherein the foot base is an elongated bar extending perpendicularly from the second end of the pivot stand.

12. The aid for the action of digging, shoveling and prying of claim 1, wherein the foot base comprises two elongate members extending from the second end of the pivot stand and forming an angle less than 180° between the two elongate members.

13. The aid for the action of digging, shoveling and prying of claim 7, wherein the one end of the pivot stand extends between the two lateral portions of the support stem partially into said gap of the support stem and is pivotally affixed to the two lateral portions of the support stem.

14. The aid for the action of digging, shoveling and prying of claim 1, wherein the top and bottom surfaces of the foot base are studded.

15. An aid for the action of digging, shoveling and prying, comprising:
(i) a collar having a base, said collar adapted to clasp about the shaft of a digging or prying implement;
(ii) a support stem affixed to the base of said collar, and extending therefrom along an axis, said support stem having at least one abutment disposed thereupon; and
(iii) a pivot stand pivotally affixed to the support stem and forming an angle therebetween, said pivot stand extending from the pivot joint to terminate at a foot base,
wherein the pivot stand abuts against the at least one abutment disposed upon the support stem when the stand is rotated to increase the angle formed between the support stem and the pivot stand,
wherein the foot base follows an arc that terminates at a point disposed along the shaft substantially near the junction of the shaft and the head of said digging or prying implement allowing the foot base to abut against the implement when the pivot stand is pivoted toward the shaft of the digging or prying implement when the collar is affixed to the shaft of a digging or prying implement and the pivot stand is rotated.

16. A method for using an aid for the action of digging, shoveling and prying, comprising the steps of:
(i) providing an aid for the action of digging and prying, comprising:
a) a collar having a base, said collar adapted to clasp about the shaft of a digging or prying implement;
(b) a support stem affixed to the base of said collar, and extending therefrom along an axis, said support stem having at least one abutment disposed thereupon; and
(c) a pivot stand pivotally affixed to the support stem and forming an angle therebetween, said stand extending from the pivot joint to terminate at a foot base, wherein the pivot stand abuts against the at least one abutment disposed upon the support stem when the pivot stand is rotated to increase the angle formed between the support stem and the pivot stand,
(ii) providing a digging, shoveling or prying implement having a shaft and a blade, said blade having an edge;
(iii) affixing the attachment collar on the shaft of the digging implement by clamping the collar about the shaft such that the shaft is divided into an upper portion and a lower portion;
(iv) positioning the digging or prying implement so that the edge of the blade is engaged with a load;
(v) pivoting the pivot stand downward, so that the foot base follows an arc that terminates at a point along the shaft of the digging or prying implement, and abuts the shaft of the digging or prying implement near the top of the blade;
(vi) placing a user's foot on the foot base and applying force on the foot base to further engage the blade with a load;
(vii) pivoting the pivot stand outwards from the shaft of the digging or prying implement so that the foot base follows an arc that terminates when a portion of the shaft abuts the at least one abutment disposed on the stem, wherein the pivot stand is rotated to a maximum angle and extended away from the shaft of the digging or prying implement, the extended pivot stand and support stem forming a lever assembly;
(viii) rocking the digging or prying implement so that the foot base rests on a flat surface in proximity of the load, whereby a fulcrum is formed by the foot base; and
(viii) applying a downward force on the upper portion of the shaft of the digging or prying implement so that the lever assembly pivots about the fulcrum causing the blade to pivot upwards carrying said load.

17. The method of claim 16, wherein the step of positioning the digging or prying implement so that the blade is engaged with a load comprises engaging the edge of the blade of a digging implement with the ground.

18. The method of claim 16, wherein the step of positioning the digging or prying implement so that the blade is engaged with a load comprises engaging the edge of the blade of a prying implement under an object.

19. The method of claim 16, wherein the step of affixing the attachment collar on the shaft of the digging implement in such a way that the shaft is divided into an upper portion and a lower portion comprises affixing the attachment collar on the shaft of the digging or prying implement such that upper portion of the shaft is longer than the lower portion of the shaft.
